(19) United States
(12) Patent Application Publication
(10) Pub. No.: US 2010/0039375 A1
(43) Pub. Date: Feb. 18, 2010

(54) Signal Processing Method of Multi-Finger Touch Supported Touch Apparatus having Hidden Physical Button

(76) Inventors: Kuo-Ming HUANG, Hsinchu (TW); Hsin-Fu Hsu, Hsinchu (TW)

Correspondence Address: LanWay IPR Services, P.O. box 223205, Chantilly, VA, 20153, US

(21) Appl. No.: 12/433,879

(22) Filed: Apr. 30, 2009

Related U.S. Application Data
(60) Provisional application No. 61/088,453, filed on Aug. 13, 2008.

(51) Int. Cl. G09G 5/00; G06F 3/041

(52) U.S. Cl. 345/156; 345/173; 178/18.03

(57) ABSTRACT

A signal processing method of a multi-finger touch supported touch apparatus having hidden physical button is applied to the multi-finger touch supported touch apparatus having at least one physical button element pair. The method includes the steps of scanning a touch sensor of the multi-finger touch supported touch apparatus continuously, judging whether the physical button element pair is pressed if a total number of the fingers detected is larger than zero and driving a corresponding touch application according to the total number of fingers of a gesture and a button. The structure of the multi-finger touch supported touch apparatus which is stacked includes a Mylar, a first adhesive layer, a printed circuit board having a first part of the physical button element pair and the touch sensor at least, a second adhesive layer, a first metallic layer for holding and a second metallic layer having a second part of the physical button element pair.

### CROSS-REFERENCE

This application claims priority from U.S. Provisional Patent Application No. 61/088,453 filed on Aug. 13, 2008.

### BACKGROUND

The present invention relates to a signal processing method of a touch apparatus, and more specifically, to the signal processing method of a multi-finger touch supported touch apparatus having hidden physical button.

Space for containing input interface of a portable electronic device such as common- or small-sized laptop and mobile phone is reduced due to the trend of thinness, light weight, fashion and integration of peripheral, and thus a conventional juxtaposition of the touch apparatus and the buttons substituting as a mouse device of the prior art is not suitable anymore. FIGS. 1 and 2 illustrate the top view of a touch apparatus and the buttons of a laptop in accordance with two preferred embodiments of the prior art. It needs larger space for the mechanism because the physical buttons 10 and 12 simulating a left and a right button of the mouse device is set apart from two sides or one side closing to user of the touch apparatus in an observable, visible and isolated way. In addition, it needs an extra FPC (flexible printed circuit board) for connection the buttons and the touch apparatus.

Moreover, the conventional electronic device and system such as laptop, mobile phone, electronic book, handwriting board, drawing board, keyboard, remote controller and so forth, are either consisting one of the touch apparatus and the physical buttons or providing one of the virtual buttons or an operating area. Thus there is no such an integrated touch apparatus design consisting of the button so far.

Accordingly, there is no such a design integrating the button into the touch apparatus and invisible in that of the appearance, and thus there is no applicable processing and supporting algorithm, driver program, input device and module in accordance with the mentioned integrated design for touch signal resulted from both single and multiple fingers or objects.

### BRIEF SUMMARY

It is therefore the objective of the present invention to provide a signal processing method of a multi-finger touch supported touch apparatus having hidden physical button for judging gesture information and button information by software or firmware and then driving the execution of corresponding functions and application programs accordingly.

It is yet the objective of the present invention to provide a signal processing method of a multi-finger touch supported touch apparatus having hidden physical button for processing, supporting and responding to the signal resulted from operating the touch apparatus via fingers or conductive objects.

It is further the objective of the present invention to provide a signal processing method of a multi-finger touch supported touch apparatus having hidden physical button for judging the number of the finger performing the gesture and pressing button by an algorithm and then driving corresponding application accordingly.

In accordance with one preferred embodiment of the present invention, the signal processing method of a multi-finger touch supported touch apparatus having hidden physical button, which is applied to the multi-finger touch supported touch apparatus having at least one physical button element pair, includes the steps of: scanning a touch sensor of the multi-finger touch supported touch apparatus by a scan routine of a firmware with a report rate continuously, interrupting the scan routine and performing an interrupt service routine one time according to a sampling rate by a timer clock counter before the end of every time slot of the report rate, and returning to an interrupt point of the scan routine when the interrupt is performed completely, wherein the interrupt service routine is applied to detect the status of an I/O port in accordance with the physical button element pair and to set the content of a corresponding button status register, and generating and transmitting a report signal to a host at the end of time slot of the report rate, wherein the report signal comprises a gesture information at least and further comprises a button information if the content of the button status register is changed.

In accordance with an alternative preferred embodiment of the present invention, the signal processing method of a multi-finger touch supported touch apparatus having hidden physical button, which is performed in each scan period continuously, includes the steps of: scanning a touch sensor of the multi-finger touch supported touch apparatus by a sensor scanning unit, counting the number of one or more fingers contacting the touch apparatus by a finger counting unit, receiving the number of fingers and determining a contacting position of the fingers contacting the surface of the touch apparatus by a finger position processing unit, transmitting the contacting position to a gesture and button processing unit, performing an interrupt service routine according to a sampling rate by a timer clock counter, wherein the interrupt service routine is applied to detect the status of an I/O port in accordance with the physical button element pair of the touch apparatus and to set the content of a corresponding button status register, and generating and transmitting a report signal to a host by the gesture and button processing unit, wherein the report signal comprises a gesture information and/or a button information, and the button information is generated if the content of the button status register is changed.

In accordance with other preferred embodiment of the present invention, the signal processing method of a multi-finger touch supported touch apparatus having hidden physical button, which is applied to the multi-finger touch supported touch apparatus having at least one physical button element pair, includes the steps of: scanning a touch sensor of the multi-finger touch supported touch apparatus continuously, judging whether the physical button element pair is pressed if a total number of the fingers detected is larger than zero, and driving a corresponding touch application according to the total number of fingers of a gesture and a button, wherein the structure of the multi-finger touch supported touch apparatus which is stacked comprises a Mylar, a first adhesive layer, a printed circuit board having a first part of the physical button element pair and the touch sensor at least, a second adhesive layer, a first metallic layer for holding and a second metallic layer having a second part of the physical button element pair, and wherein a first area of the second adhesive layer in accordance with the first part and a second area of the first metallic layer are hollow.

Accordingly, the signal processing method of a multi-finger touch supported touch apparatus having hidden physical button, which is applied to the multi-finger touch supported touch apparatus having at least one physical button element pair behind the touch apparatus such as touchpad module, and thus it reduces the space for the mechanism and eliminates the extra FPC due to the integration of the touch apparatus and the physical button. In addition, the detecting and interpreting method of multi-finger or multi-object operation including but not to be limited by U.S. Pat. No. 5,825,352 works to the touch apparatus having hidden physical button well. Moreover, the button setting behind the under side and the edge provides the response to users during operating, and the location, the number and the appearance of the button such as flat, protruded, patterned and illuminated are not to be limited.

For further understanding of these and other objectives, the nature and advantages of the invention, reference should be made to the following description taken in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a top view of a configuration of a touch apparatus and the physical buttons of a laptop in accordance with a preferred embodiment of the prior art.

FIG. 2 is a top view of a configuration of a touch apparatus and the physical buttons of a laptop in accordance with an alternative preferred embodiment of the prior art.

FIG. 3 is a sectional view of a multi-finger touch supported touch apparatus having hidden physical button in accordance with a preferred embodiment of the present invention.

FIG. 4 is an assembled view of a multi-finger touch supported touch apparatus having hidden physical button in accordance with a preferred embodiment of the present invention.

FIG. 5 is a flowchart of a signal processing method of a multi-finger touch supported touch apparatus having hidden physical button in accordance with a preferred embodiment of the present invention.

FIG. 6 is a flowchart of a signal processing method of a multi-finger touch supported touch apparatus having hidden physical button in accordance with an alternative preferred embodiment of the present invention.

FIG. 7 is a flowchart of a signal processing method of a multi-finger touch supported touch apparatus having hidden physical button in accordance with other preferred embodiment of the present invention.

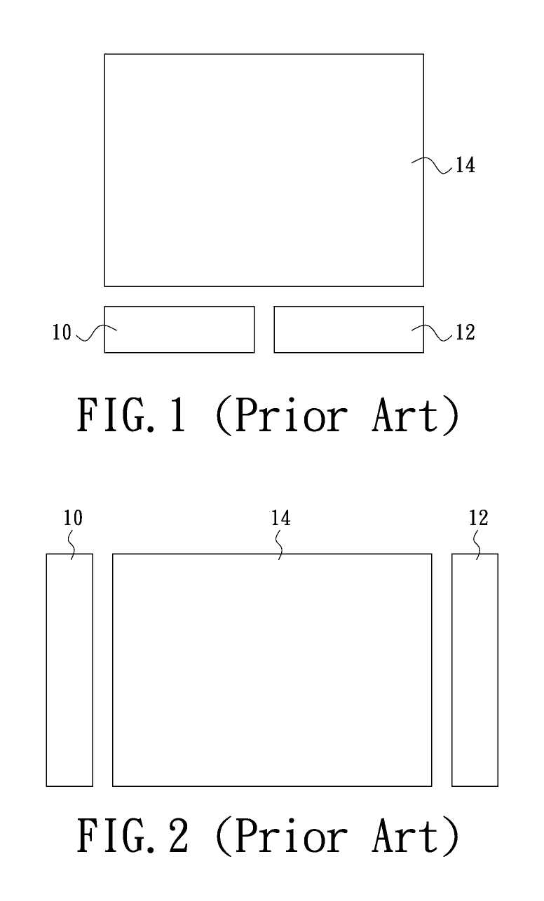

### DETAILED DESCRIPTION

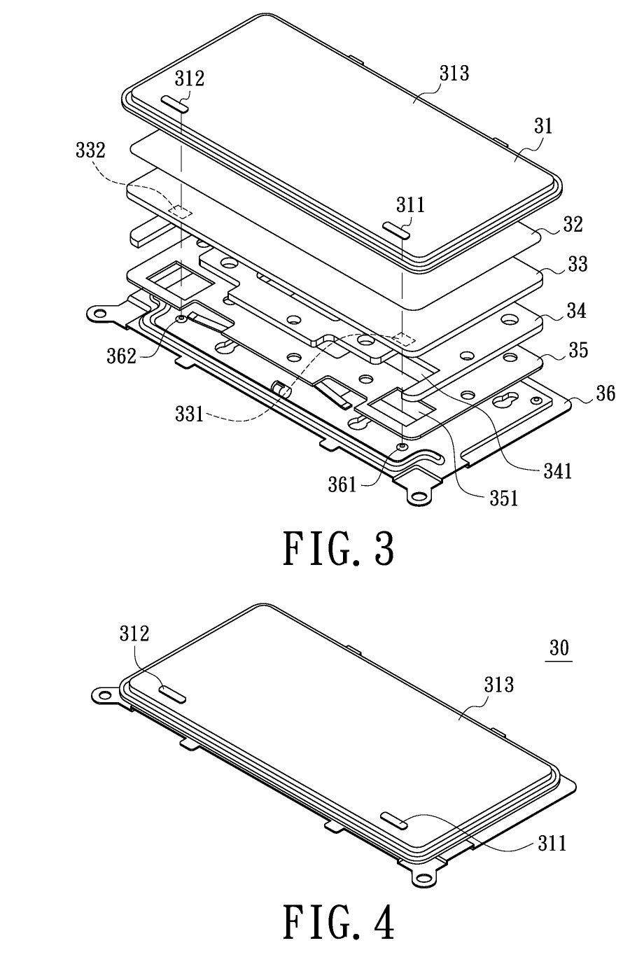

Please refer to FIGS. 3 and 4 indicating a sectional and an assembled view of a preferred embodiment of a multi-finger touch supported touch apparatus having hidden physical button of the present invention. As shown in FIG. 3, the structure of a multi-finger touch supported touch apparatus 30 such as a touchpad module is stacked and includes a Mylar 31, a first adhesive layer 32, a printed circuit board 33 having the first part 331 and 332 of the physical button element pair and the touch sensor (or so-called conductive trace, not shown), a second adhesive layer 34, a first metallic layer 35 for holding and a second metallic layer 36 having the second part 361 and 362 of the physical button element pair. In the embodiment, the Mylar 31 is touchable for finger and object, and it has advantage of good looks, anti-scrape, sense of touch enhancement and durable. The first adhesive layer 32 and the second adhesive layer 34 are the adhesive 467 and adhesive UT 1400 for exemplary. The under side of the printed circuit board 33 as a substrate of the touch apparatus module is equipped with the common detecting element such as IC (integrated circuit), connector (not shown) and further first part 331 of the physical button element pair set at one corner at least. A first area 341 of the second adhesive layer 34 in accordance with the first part 331 and a second area 351 of the first metallic layer 35 are hollow for the first part 33 land the second part 361 of the physical button element pair to contact each other. Similarly, the first area of the second adhesive layer 34 in accordance with the first part 332 and a second area of the first metallic layer 35 are hollow. In addition, the button setting behind the under side and the edge provides the response to users during operating by employing a tactile switch or a metal dome in practice, and the location, the number and the appearance of the button such as flat, protruded, patterned and illuminated is determined according to the real demand, specification or cost. Moreover, users may touch the button area 311 and 312 and the touch active area 313 of the assembled multi-finger touch supported touch apparatus 30 as shown in FIG. 4. It reduces the space for the mechanism and eliminates the extra FPC for connecting the left and the right button by integrating the physical button to the under side of the printed circuit board 33, and it fulfills the demand on the equipment of larger touch apparatus of small-sized laptop for more fancy touch applications.

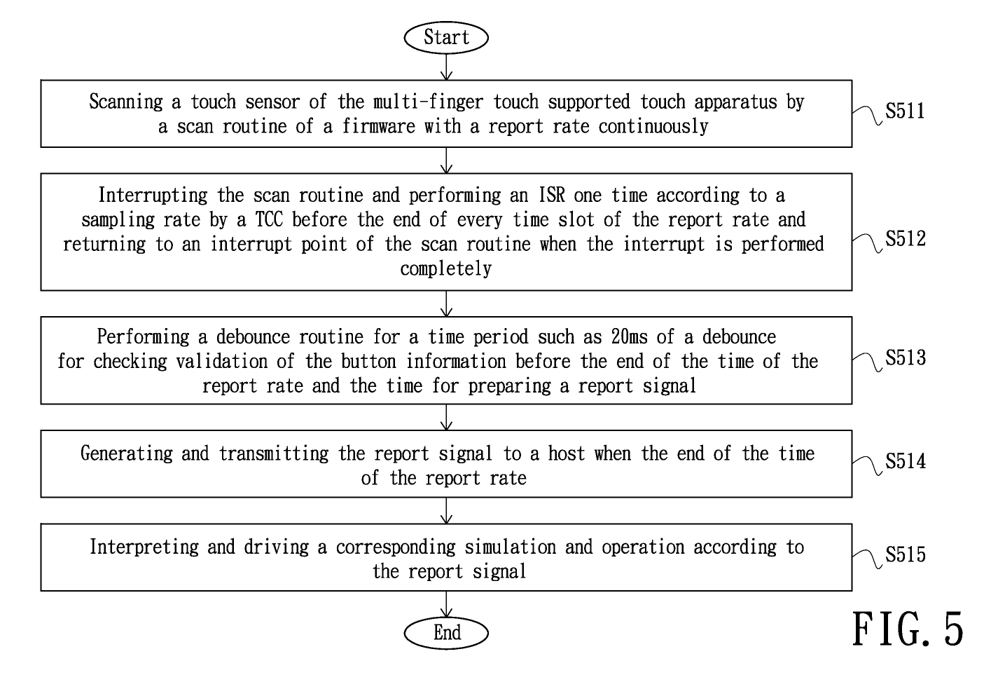

Please refer to FIGS. 3, 4 and 5 indicating the steps of a signal processing method of a multi-finger touch supported touch apparatus having hidden physical button of a preferred embodiment of the present invention. In the embodiment, the signal processing method is applied to the multi-finger touch supported touch apparatus 30 as shown in FIG. 4 for exemplary, and it includes the steps of: scanning a touch sensor of the multi-finger touch supported touch apparatus 30 by a scan routine of a firmware with a report rate such as 12.5 ms continuously in step S511, interrupting the scan routine and performing an ISR (interrupt service routine) one time according to a sampling rate such as 500 μs by a TCC (timer clock counter) before the end of every time slot of the report rate 12.5 ms, and returning to an interrupt point of the scan routine when the interrupt is performed completely in step S512. The TCC is counting incrementally, and the ISR is applied to detect the status of an I/O port in accordance with the physical button element pair and to set the content of a corresponding button status register. Then, performing a debounce routine for a time period such as 20 ms of a debounce for checking validation of the button information before the end of the time of the report rate and the time for preparing a report signal in step S513, and generating and transmitting the report signal to a host when the end of the time of the report rate 12.5 ms in step S514. The report signal comprises a gesture information at least and further a button information if the content of the button status register is changed. Moreover, the method further includes the steps of interpreting and driving a corresponding simulation and operation according to the report signal in step S515. In alternative embodiment, the method further includes the steps of scanning the touch sensor again to obtain the adjusted gesture information and the adjusted button information after step S512. Herein, the gesture information comprises the number of the fingers and/or the positions of the fingers, and the button information comprises the number of the button pressed and/or the physical button element pair which is tapped or pressed.

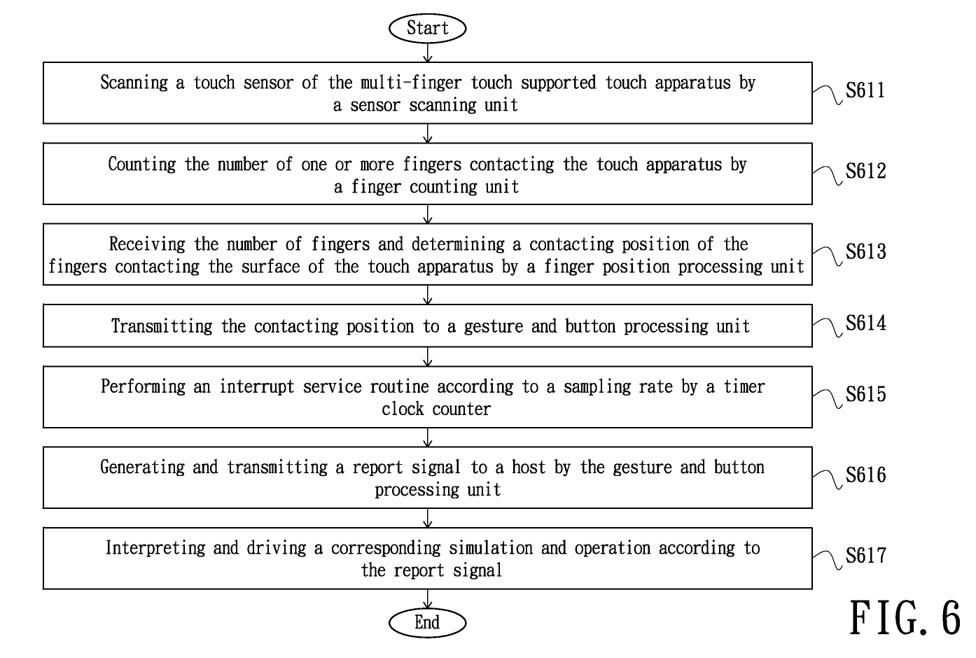

Please refer to FIGS. 3, 4 and 6 indicating the steps of a signal processing method of a multi-finger touch supported touch apparatus having hidden physical button of an alternative preferred embodiment of the present invention. In this embodiment, the signal processing method, which is performed in each scan period continuously and applied to the multi-finger touch supported touch apparatus 30 as shown in FIG. 4 for exemplary, includes the steps of: scanning a touch sensor of the multi-finger touch supported touch apparatus 30 by a sensor scanning unit in step S611, counting the number of one or more fingers contacting the touch apparatus by a finger counting unit in step S612, receiving the number of fingers and determining a contacting position of the fingers contacting the surface of the touch apparatus by a finger position processing unit in step S613, transmitting the contacting position to a gesture and button processing unit in step S614, performing an interrupt service routine according to a sampling rate by a timer clock counter in step S615. The interrupt service routine detects an I/O port status in accordance with the physical button element pair and set the content of a corresponding button status register. Then, the method further includes the step of generating and transmitting a report signal to a host by the gesture and button processing unit in step S616. The report signal comprises a gesture information and/or a button information which is generated if the content of the button status register is changed. Moreover, the method further includes the step of interpreting and driving a corresponding simulation and operation according to the report signal in step S617. In alternative embodiment, the method further includes the steps of scanning the touch sensor again to obtain the adjusted gesture information and the adjusted button information and performing a debounce routine before transmitting the report signal. Herein, the gesture information comprises the number of the fingers and/or the positions of the fingers, and the button information comprises the number of the button pressed and/or the physical button element pair which is tapped or pressed.

Please refer to FIGS. 3, 4 and 7 indicating the steps of a signal processing method of a multi-finger touch supported touch apparatus having hidden physical button of other preferred embodiment of the present invention. In the embodiment, the signal processing method is applied to the multi-finger touch supported touch apparatus 30 which is stacked comprises a Mylar, a first adhesive layer, a printed circuit board having a first part of the physical button element pair and the touch sensor at least, a second adhesive layer, a first metallic layer for holding and a second metallic layer having a second part of the physical button element pair, and wherein a first area of the second adhesive layer in accordance with the first part and a second area of the first metallic layer are hollow.

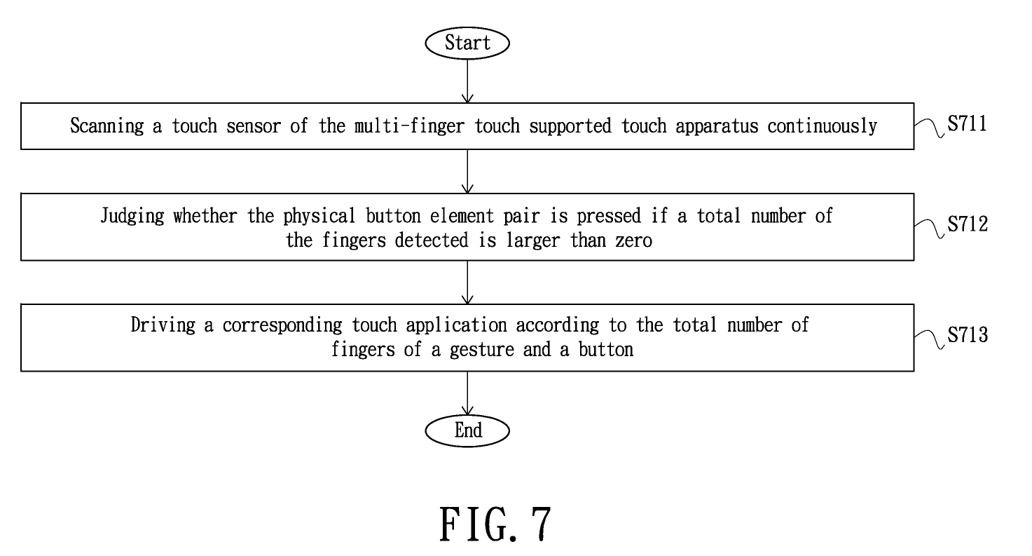

Hence, the signal processing method as shown in FIG. 7 includes the steps of: scanning a touch sensor of the multi-finger touch supported touch apparatus 30 continuously in step S711, judging whether the physical button element pair is pressed if a total number of the fingers detected is larger than zero in step S712 and driving a corresponding touch application according to the total number of fingers of a gesture and a button in step S713. Furthermore, the touch application is a tap or a double tap if one preset button element pair is pressed and the total number of the fingers detected is one, an one-finger application if one preset physical button element pair is pressed and the total number of the fingers detected is two, a simulation of middle button of mouse if two preset physical button element pairs are pressed and the total number of the fingers detected is two and a multi-finger application if the total number of the fingers detected is larger than two and one or two preset physical button element pairs are pressed.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A signal processing method of a multi-finger touch supported touch apparatus having hidden physical button which is applied to the multi-finger touch supported touch apparatus having at least one physical button element pair, the method comprising:
scanning a touch sensor of the multi-finger touch supported touch apparatus by a scan routine of a firmware with a report rate continuously;
interrupting the scan routine and performing an interrupt service routine one time according to a sampling rate by a timer clock counter before the end of every time slot of the report rate, and returning to an interrupt point of the scan routine when the interrupt is performed completely, wherein the interrupt service routine is applied to detect the status of an I/O port in accordance with the physical button element pair and to set the content of a corresponding button status register; and
generating and transmitting a report signal to a host at the end of time slot of the report rate, wherein the report signal comprises a gesture information at least and further comprises a button information if the content of the button status register is changed.

2. The signal processing method of multi-finger touch supported touch apparatus having hidden physical button of claim 1, further comprising:
interpreting and driving a corresponding simulation and operation according to the report signal.

3. The signal processing method of multi-finger touch supported touch apparatus having hidden physical button of claim 1, wherein the timer clock counter is counting incrementally.

4. The signal processing method of multi-finger touch supported touch apparatus having hidden physical button of claim 1, wherein if the content of the button status register is changed, further comprising:
performing a debounce routine for a time period of a debounce for checking validation of the button information before the end of the time of the report rate and the time for preparing the report signal.

5. The signal processing method of multi-finger touch supported touch apparatus having hidden physical button of claim 1, wherein if the content of the button is changed, further comprising:
scanning the touch sensor again to obtain the adjusted gesture information and the adjusted button information, wherein the gesture information comprises the number of the fingers and/or the positions of the fingers, and the button information comprises the number of the button pressed and/or the physical button element pair which is tapped or pressed.

6. The signal processing method of multi-finger touch supported touch apparatus having hidden physical button of claim 1, wherein the structure of the multi-finger touch supported touch apparatus which is stacked comprises a Mylar, a first adhesive layer, a printed circuit board having a first part of the physical button element pair and the touch sensor at least, a second adhesive layer, a first metallic layer for holding and a second metallic layer having a second part of the physical button element pair, and wherein a first area of the second adhesive layer in accordance with the first part and a second area of the first metallic layer are hollow.

7. A signal processing method of a multi-finger touch supported touch apparatus having hidden physical button which is performed in each scan period continuously, the method comprising:
scanning a touch sensor of the multi-finger touch supported touch apparatus by a sensor scanning unit;
counting the number of one or more fingers contacting the touch apparatus by a finger counting unit;
receiving the number of fingers and determining a contacting position of the fingers contacting the surface of the touch apparatus by a finger position processing unit;
transmitting the contacting position to a gesture and button processing unit;
performing an interrupt service routine according to a sampling rate by a timer clock counter, wherein the interrupt service routine is applied to detect the status of an I/O port in accordance with the physical button element pair of the touch apparatus and to set the content of a corresponding button status register; and
generating and transmitting a report signal to a host by the gesture and button processing unit, wherein the report signal comprises a gesture information and/or a button information, and the button information is generated if the content of the button status register is changed.

8. The signal processing method of multi-finger touch supported touch apparatus having hidden physical button of claim 7, further comprising:
interpreting and driving a corresponding simulation and operation according to the report signal.

9. The signal processing method of multi-finger touch supported touch apparatus having hidden physical button of claim 7, wherein the content of the button is changed, further comprising:
scanning the touch sensor again to obtain the adjusted gesture information and the adjusted button information, wherein the gesture information comprises the number of the fingers and/or the positions of the fingers, and the button information comprises the number of the button pressed and/or the physical button element pair which is tapped or pressed; and
performing a debounce routine before transmitting the report signal.

10. The signal processing method of multi-finger touch supported touch apparatus having hidden physical button of claim 7, wherein the structure of the multi-finger touch supported touch apparatus which is stacked comprises a Mylar, a first adhesive layer, a printed circuit board having a first part of the physical button element pair and the touch sensor at least, a second adhesive layer, a first metallic layer for holding and a second metallic layer having a second part of the physical button element pair, and wherein a first area of the second adhesive layer in accordance with the first part and a second area of the first metallic layer are hollow.

11. A signal processing method of a multi-finger touch supported touch apparatus having hidden physical button which is applied to the multi-finger touch supported touch apparatus having at least one physical button element pair, the method comprising:
scanning a touch sensor of the multi-finger touch supported touch apparatus continuously;
judging whether the physical button element pair is pressed if a total number of the fingers detected is larger than zero; and
driving a corresponding touch application according to the total number of fingers of a gesture and a button, wherein the structure of the multi-finger touch supported touch apparatus which is stacked comprises a Mylar, a first adhesive layer, a printed circuit board having a first part of the physical button element pair and the touch sensor at least, a second adhesive layer, a first metallic layer for holding and a second metallic layer having a second part of the physical button element pair, and wherein a first area of the second adhesive layer in accordance with the first part and a second area of the first metallic layer are hollow.

12. The signal processing method of multi-finger touch supported touch apparatus having hidden physical button of claim 11, wherein the touch application is a tap or a double tap if one preset physical button element pair is pressed and the total number of the fingers detected is one.

13. The signal processing method of multi-finger touch supported touch apparatus having hidden physical button of claim 11, wherein the touch application is an one-finger application if one preset physical button element pair is pressed and the total number of the fingers detected is two.

14. The signal processing method of multi-finger touch supported touch apparatus having hidden physical button of claim 11, wherein the touch application is a simulation of middle button of mouse if two preset button element pairs are pressed and the total number of the fingers detected is two.

15. The signal processing method of multi-finger touch supported touch apparatus having hidden physical button of claim 11, wherein the touch application is a multi-finger application if the total number of the fingers detected is larger than two and one or two preset button element pairs are pressed.
